(19) United States
(12) Patent Application Publication
(10) Pub. No.: US 2011/0122309 A1
(43) Pub. Date: May 26, 2011

(54) APPARATUS FOR DETECTING IN-FOCUS STATE

(75) Inventor: Koichi SATO, Saitama (JP)

(73) Assignee: HOYA CORPORATION, Tokyo (JP)

(21) Appl. No.: 12/949,040

(22) Filed: Nov. 18, 2010

(30) Foreign Application Priority Data
Nov. 20, 2009 (JP) 2009-265419

(51) Int. Cl. G03B 13/00

(52) U.S. Cl. 348/345; 348/E05.022

(57) ABSTRACT

An apparatus that detects an in-focus state has a plurality of line sensors arranged on a projection area of an optical image-forming system, each line sensor comprising photoelectric converters an storages; a plurality of monitor sensors arranged on the projection area, each monitor sensor being adjacent to a corresponding line sensor and monitoring a quantity of light incident on a corresponding line sensor; an accumulation termination detector that detects a termination timing of an accumulation of electric charge in the plurality of line sensors on the basis of monitor signals output from the plurality of monitor sensors; an electric charge transfer processor that transfers electric charges accumulated in the photoelectric converters to the storages; a signal output processor that reads electric charges temporarily stored in the storages to output image signals corresponding to an object image; and an electric charge transfer controller that adjusts an electric charge transfer time of a target line sensor in response to intensity of light incident on a corresponding monitor sensor.

### BACKGROUND OF THE INVENTION

1. Field of the Invention

The present invention relates to a camera with an AF (Auto Focus) mechanism using a phase-difference method, such as an SRL (Single Reflex Lens) camera. In particular, it relates to a control of line sensors.

2. Description of the Related Art

An SRL-type camera is equipped with an AF mechanism based on a phase-difference method, which has an optical image-forming system and a sensor module that is constructed from a focus-detection device, such as an IC chip. The optical image-forming system has a separator lens and a condenser lens, whereas the focus-detection device is equipped with a series of line sensors that are arrayed within a projection area of the optical system. Each line sensor is constructed of a plurality of pairs of photodiodes.

In an AF sensor, an optical system divides a ray bundle from an object into two ray bundles to project a pair of images onto the pairs of line-sensors. Each line-sensor outputs image-pixel signals by photoelectric conversion, and a difference between the positions of the two images, namely a phase difference, is detected. The difference represents an out-of-focus magnitude. Whether or not an object is in focus can be determined by the detected out-of-focus magnitude. When the object is out of focus, an amount of movement by the focusing lens and a shift in its direction are determined. Then, the focusing lens is driven.

Generally, a line sensor is an electric charge storage/accumulation-type sensor, and an accumulation period is adjusted on the basis of a monitor sensor that is arrayed alongside the line sensor. For example, U.S. Pat. No. 7,493,034, U.S. Pat. No. 6,937,818, U.S. Pat. No. 4,876,603 discloses adjustment of an accumulation of electric charges using a monitor sensor. A monitor sensor, which has photo-electric converter such as photodiodes, consistently detects the intensity of light and outputs monitor signals in order to prevent the target line sensor from receiving a quantity of light exceeding a dynamic range, which would cause electric charges to overflow from the line sensor. The amount of light that each line sensor receives varies according to the brightness distribution of an object. Therefore, a charge-accumulation period is controlled independently for each line sensor.

A level of a monitor signal is compared with a predetermined threshold level during an accumulation of electric charges. When a monitor signal exceeds a predetermined threshold value, a corresponding line sensor stops the accumulation of electric charges by opening a transfer gate, and accumulated electric charges are temporarily stored in a memory (e.g., a capacitor) of the line sensor. After the accumulation of electric charges in all of the line sensors is completed, a series of image-pixel signals that corresponds to image signals of an object are output from the line sensors. At this time, the series of image-pixel signals are subjected to a noise reduction process, and converted to digital signals. The output digital image signals are used for calculating an amount of defocus, and a focusing lens is driven by an amount of defocus. The output of image signals is continued until an object image becomes in-focus.

While reading accumulated electric charges from a line sensor, electric charges generated in photodiodes by incident light are removed so that they do not combine with the newly accumulated electric charges in the line sensor. However, when high-intensity light is incident on the line sensor, surplus electric charges occasionally pass through the transfer gate, and the transferred surplus electric charges are mixed in with originally accumulated electric charges. Consequently, the output level of the line sensor becomes unstable.

### SUMMARY OF THE INVENTION

An object of the present invention is to provide a focus detection apparatus that is capable of correctly detecting the brightness level of an object regardless of intensity of incident light.

An apparatus for detecting a focus, according to the present invention, has a plurality of line sensors arranged on a projection area of an optical image-forming system, each line sensor comprising photoelectric converters and storage; a plurality of monitor sensors arranged on the projection area, each monitor sensor being adjacent to a corresponding line sensor and monitoring a quantity of light incident on a corresponding line sensor; an accumulation termination detector that detects when an accumulation of electric charges in the plurality of line sensors is terminated on the basis of monitor signals output from the plurality of monitor sensors; an electric charge transfer processor that transfers electric charges accumulated in the photoelectric converters to the storage; a signal output processor that reads electric charges temporarily stored in the storage to output image signals corresponding to an object image; and an electric charge transfer controller that adjusts an electric charge transfer time interval in response to the intensity of light incident on a corresponding monitor sensor.

### BRIEF DESCRIPTION OF THE DRAWINGS

The present invention will be better understood from the description of the preferred embodiment of the invention set forth below together with the accompanying drawings, in which:

FIG. 1 is a schematic diagram of the inner construction of a digital camera according to the embodiment;

FIG. 2 is a view showing an arrangement construction of the focus detector;

FIG. 3 is a block diagram of the focus detector;

FIG. 4 is a view showing a control of an accumulation of electric charges;

FIG. 5 is a view showing a scanning or reading process of image-pixel signals;

FIG. 6 is a schematic diagram of one image-pixel signal-reading circuit for the line sensor;

FIG. 7 is a schematic diagram of one image-pixel signal-reading circuit for the monitor sensor;

FIG. 8 is a graph representing a relationship between a time interval of an electric charge transfer and the quantity of electric charges to be transferred;

FIG. 9 shows a flowchart representing a control process for an electric charge transfer time, which is carried out by the logic circuit;

FIG. 10 is a timing chart for an electric charge transfer process; and

FIG. 11 is a timing chart in a case characterized by extremely weak incident light.

### DESCRIPTION OF THE PREFERRED EMBODIMENTS

Hereinafter, the preferred embodiment of the present invention is described with reference to the attached drawings.

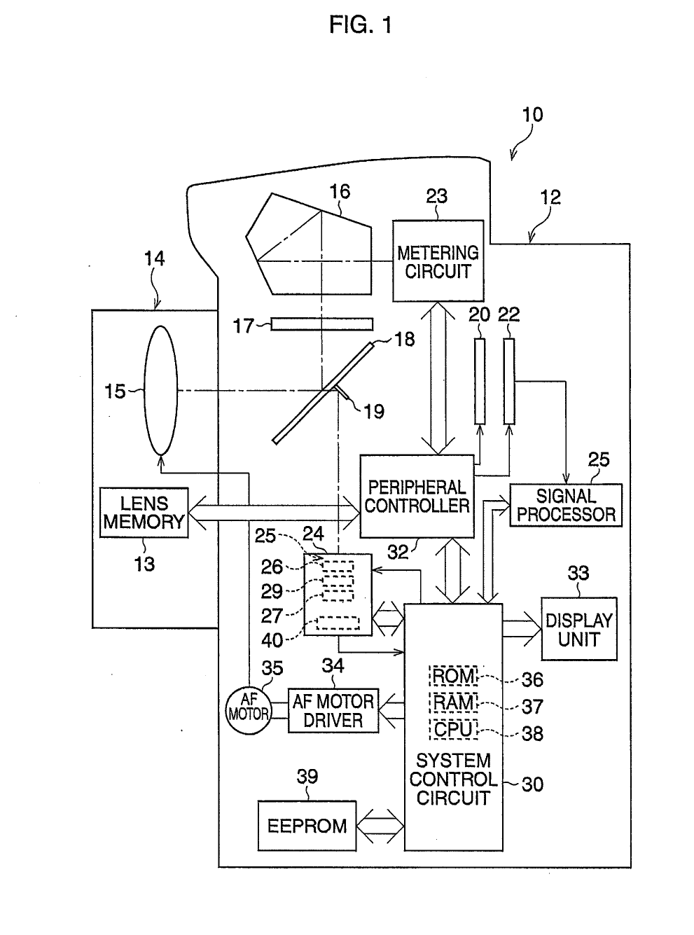

FIG. 1 is a schematic diagram of the inner construction of a digital camera according to the embodiment.

The SLR-type digital camera 10 is equipped with a body 12 and an interchangeable lens 14 removably attached to the body 12. The body 12 has a pentaprism 16, a quick return mirror 18, a focal plane shutter 20, and an image sensor 22 (e.g., a CCD or CMOS image sensor).

A metering circuit 23 is arranged adjacent to the pentaprism 16, and detects the brightness of an object image formed by a pint glass 17 disposed above the quick return mirror 18, in accordance with a TTL metering method. An AF module 24, which is disposed below the quick return mirror 18, detects a focus state in accordance with a phase-difference method.

A system control circuit 30 having a ROM unit 36, a RAM unit 37, and a CPU 38 controls the operation of the camera and outputs control signals to the metering circuit 23, the AF module 24, a peripheral controller 32, a display unit 34, and EEPROM 39, etc. The peripheral controller 32 controls an exposure mechanism including the focal plane shutter 20, an iris (not shown), and the image sensor 22. Also, the peripheral controller 32 obtains lens information from a lens memory 13 in the interchangeable lens 14.

When the camera 10 is powered ON a photographing mode is activated. Light passing through a photographing optical system 15 is directed to the pentaprism 16 via the quick return mirror 18. A user confirms an object through a viewfinder (not shown). When a release button (not shown) is depressed halfway, the metering circuit 23 detects the brightness of the object image and the AF module 24 detects an in-focus state.

A portion of the light passing through the photographing optical system 15 passes through the quick return mirror 18 and proceeds to the AM module 24 via a sub-mirror 19. The AF module 24 has an optical image-forming system 25 including a condenser lens 26, a separator lens 27, a separator mask 29, and a focal detector 40. The separator mask 29 is arranged on a conjugate surface equivalent to an image-forming surface (i.e., a photo-receiving surface of the image sensor 22), and divides an object image into two pairs of images. The separator lens 27 forms the two pairs of images on a photo-receiving surface of the AF module 24. Herein, the two pairs of images are perpendicular to each other. The focus detector 40 outputs image signals of the projected object images to the system control circuit 30.

The system control circuit 30 calculates an out-of-focus magnitude and carries out a focus-adjustment process. Concretely, the system control circuit 30 outputs control signals to an AF motor driver 34 based on the out-of-focus magnitude and out-of-focus direction. The AF motor 35 repositions a focusing lens in the photographing optical system 15 on the basis of driving signals supplied by the AF motor driver 34. The focus detection and lens-driving processes are both carried out until an object image is in focus. After the AF adjustment and brightness detection processes are carried out, the system control circuit 30 calculates exposure values, i.e., a shutter speed and an F number.

Then, when the release button is fully depressed, a series of recording processes are carried out. Concretely, an object target image is formed on the image sensor 22 by the motions of the quick return mirror 18, the iris and the shutter 20, and then one frame's worth of image-pixel signals are read from the image sensor 22. A signal processor 25 generates digital image data from the read image-pixel signals. The generated image data is stored in a memory (not shown) such as a memory card.

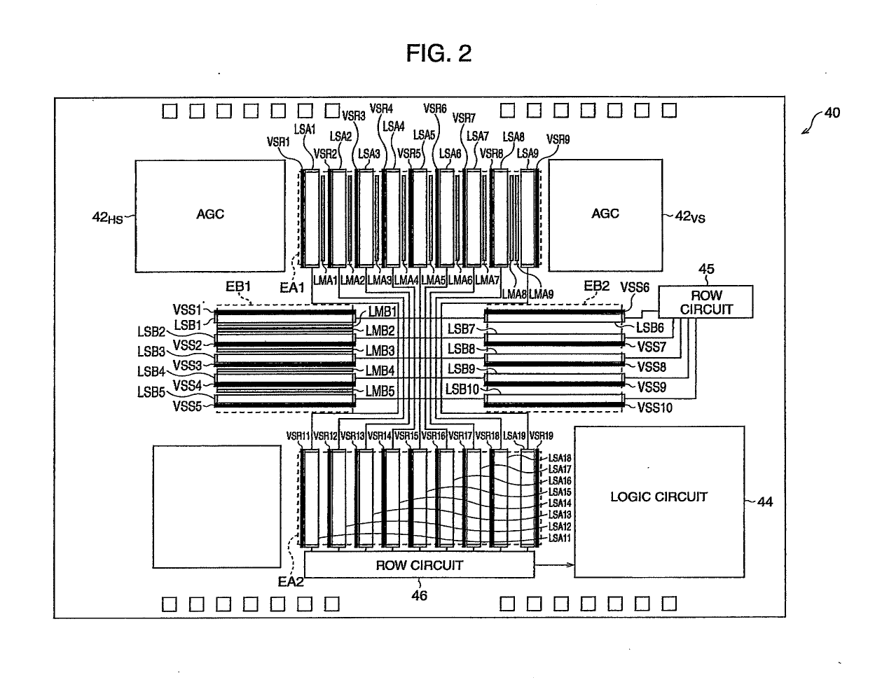

FIG. 2 illustrates an arrangement construction of the focus detector.

The focus detector 40 is constructed from an IC (Integrated Circuit) chip on which a plurality of CMOS-type line sensors is arranged. On the surface of the focus detector 40, a pair of line-sensor groups EA1 and EA2 is disposed so as to be opposite from each other along the vertical direction of the photo-receiving surface, and a pair of line-sensor groups EB1 and EB2 is disposed so as to be opposite from each other along the horizontal direction. Note that the vertical direction corresponds to the vertical direction of the photographed object image, and the horizontal direction corresponds to the horizontal direction of the object image. The line-sensor groups EA1 and EA2 and the line-sensor groups EB1 and EB2 surround the center portion of the detector's surface.

One pair of object images obtained from pupil division by the optical image-forming system 25 is projected onto the areas in which the line-sensor groups EA1 and EA2 are disposed, and the other pair of object images is projected onto areas in which the line-sensor groups EB1 and EB2 are disposed.

Each line-sensor group is composed of a plurality of line sensors arrayed along the horizontal (left-right) direction or vertical (upper-lower) direction at predetermined intervals. The line-sensor groups EA1 and EA2 are arrayed along the left-right direction, whereas line-sensor groups EB1 and EB2 are arrayed along the upper-lower direction. Each line-sensor has a plurality of photo-converters (herein, photodiodes) arrayed in a line.

The line-sensor group EA1 is composed of nine line sensors LSA1-LSA9, with each line sensor functioning as a standard line sensor. On the other hand, each one of the nine line sensors LSA11-LSA19 in the line-sensor group EA2 functions as a reference line sensor. Similarly, each one of the five line sensors from LSB1 to LSB5 functions as a standard line sensor, while each one of the five line sensors from LSB6 to LSB10 functions as a reference line sensor.

For the line-sensor groups EA1 and EB1, monitor sensors from LMA1 to LMA9 and from LMB1 to LMB5 are disposed alongside the line sensors from LSA1 to LSA9 and from LSB1 to LSB5, respectively. Each monitor sensor is composed of a plurality of photodiodes that divides the area of the neighboring line sensor into multiple sections. Each of the monitor sensors from LMA1 to LMA9 extends along the longitudinal direction, namely, alongside a neighboring line sensor, and outputs a “monitor signal” representing a quantity of light (intensity of light). Similarly, each monitor sensor from LMB1 to LMB5 also outputs a monitor signal.

Furthermore, vertical shift registers VSR1-VSR9 and VSS1-VSS5 are arranged adjacent to line sensors LSA1-LSA9 and LSB1-LSB5, respectively. Similarly, vertical shift registers VSR11-VSR19 and VSS6-VSS10 are arranged adjacent to line sensors LSA11-LSA19 and LSB6-LSB10, respectively. Also, a series of black level monitoring sensors (not shown) are arranged adjacent to the line sensors in line-sensor groups EA1 and EB1.

AGC (Auto Gain Control) circuits 42_{HS} and 42_{VS} adjust the gains of monitor signals received from the monitor sensors LMA1-LMA9 and LMB1-LMB5. Furthermore AGC circuits 42_{HS} and 42ᵥₛ compares the values of the monitor signals with a threshold value. Each AGC circuit determines whether a quantity of light incident on a target line sensor is sufficient for detecting an in-focus state. The threshold value is predetermined so as to prevent an overflow of light exceeding the dynamic range of a line sensor.

When the monitor signal exceeds or reaches the threshold value, the quantity of light incident on it is determined to be sufficient for detecting the in-focus state. Each AGC circuit outputs a monitor signal that indicates the termination of an accumulation of an electric charge to a logic circuit 44 (hereinafter, called a “termination signal”). The logic circuit 44 outputs a control signal for terminating the accumulation to the target line sensor. Consequently, the accumulation (integration) of electric charges by the target line sensor stops and the accumulated electric charges are temporarily stored in the line sensor.

As described later, an accumulation period of electric charges is controlled for a plurality of target areas that is defined on each line sensor. Therefore, the timing of the completion of the accumulation of electric charges varies with each line sensor's target area. Once the accumulation of electric charges is finished for all of the line sensors, the electric charges accumulated in each line sensor are output to the system control circuit 30, in order, by an image-pixel reading circuit (herein, not shown); the vertical shift registers VSR1-VSR9, VSR11-VSR19, VSS1-VSS5 and VSS6-VSS10; and by the output electric charge transfer circuits 45 and 46 that include horizontal shift registers (hereinafter, called a “row circuit”). In the row circuits 45 and 46, a noise reduction process and an amplifying process is carried out on the read image-pixel signals. The amplified image-pixel signals are output to the system control circuit 30 shown in FIG. 1. In the system control circuit 30, an out-of-focus magnitude is obtained from the phase difference between the pairs of image-pixel signals.

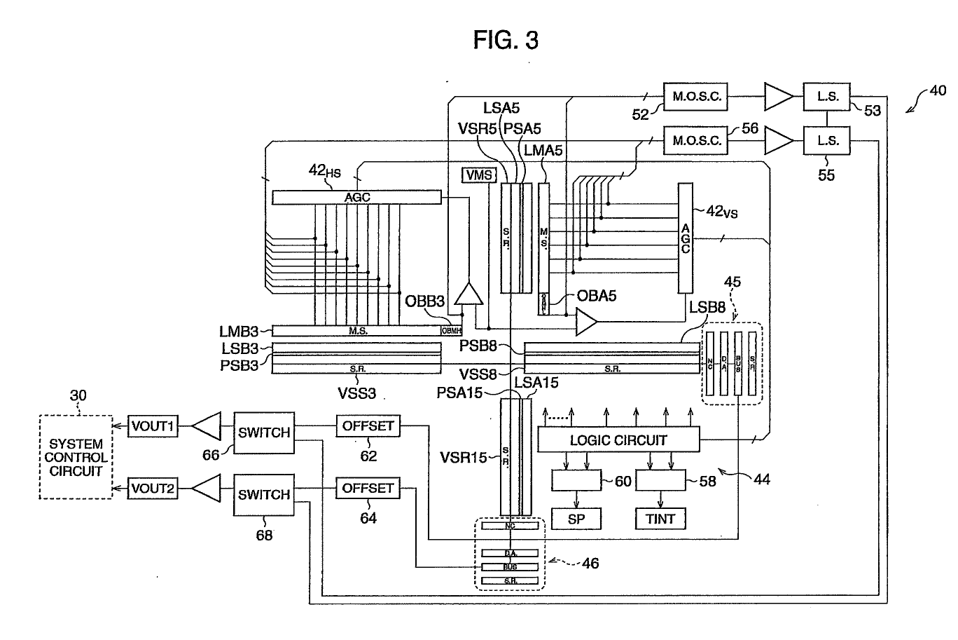

Hereinafter, a control of the accumulation of electric charges and a method for reading image-pixel signals are explained with reference to FIGS. 3-5.

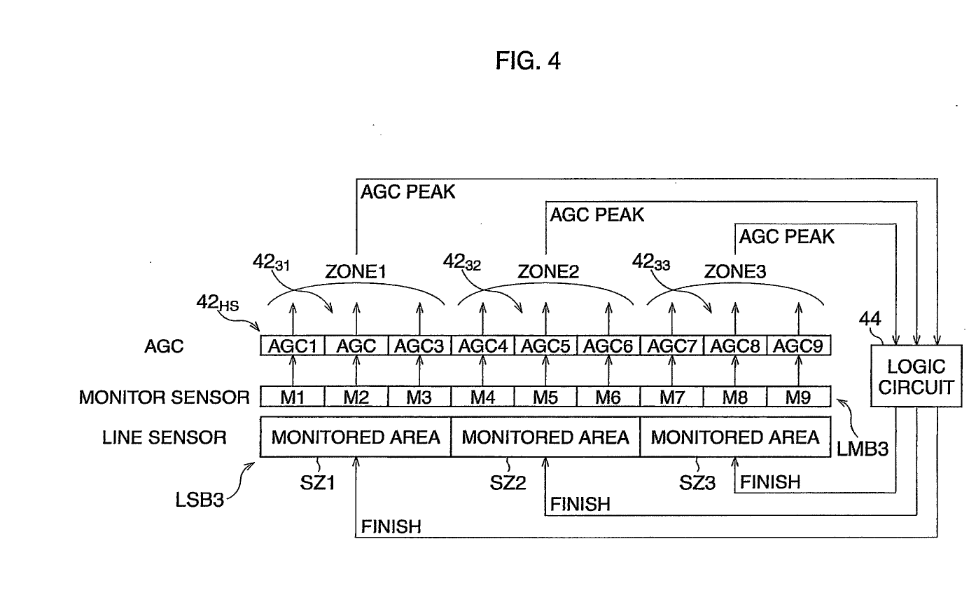

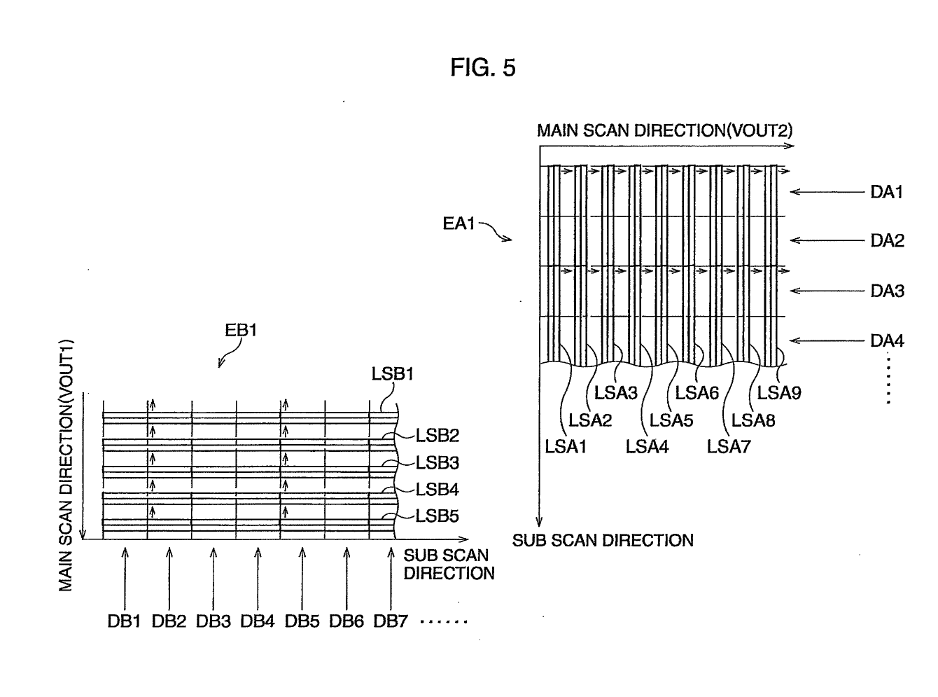

FIG. 3 is a block diagram of the focus detector 40. FIG. 4 is diagram of a control for the accumulation of electric charges. And FIG. 5 is a schematic diagram of a process for scanning or reading image-pixel signals.

Note that FIG. 3 illustrates only the pair of line sensors LSA5 and LSA15 along the vertical direction, the pair of line sensors LSB3 and LSB8 along the horizontal direction, and the corresponding monitor sensors LMA5 and LMB3. The other line sensors and monitor sensors have been omitted.

The line sensor LSA5 shown in FIG. 3 has a series of pairs of photodiodes aligned in the vertical direction. The image-pixel signal circuit PSA5 aligned in the vertical direction is intervening between the series of pairs of photodiodes. Similarly, the line sensors LSA15, LSB3, and LSB8 have a series of pairs of photodiodes, respectively, and the image-pixel reading circuits PSA15, PSB3, and PSB8 are arranged between the series of pairs of photodiodes, respectively. Electric charges accumulated in each pair of photodiodes are read by a corresponding image-pixel signal circuit as “image-pixel signals”.

The monitor sensor LMA 5 arranged alongside the line sensor LSA5 is constructed of a plurality of fine photosensors (herein, not shown), which is aligned in the vertical direction. Each fine photosensor is equipped with a photoelectric converter (e.g., photodiode). Electric charges accumulated in the fine photosensor are read by an image-pixel reading circuit (herein, not shown). The monitor sensor LMB3 next to the line sensor LSB3 has a series of fine photosensors, similarly to the monitor sensor LMA5.

A series of monitor signals output from the monitor sensor LMB3 are input to the AGC circuit 42_{HS}. As mentioned before, the AGC circuit 42_{HS} detects whether the monitor signal levels exceed the threshold level. When the value of a monitor signal exceeds the threshold level, a termination signal that indicates an excess or arrival with respect to the threshold level is output to the logic circuit 44. The threshold level is predetermined in accordance with the dynamic range of the line sensor LSB3. The AGC circuit 42_{VS} connected to the monitor sensor LMA5 detects whether monitor signals from the monitor sensor LMA5 exceed the threshold level, similarly to the AGC 42_{HS}.

In FIG. 4, the line sensor LSB3 and the monitor sensor LMB3 are shown. The monitoring of the line sensors is carried out for a plurality of partial areas, i.e., distance-measuring zones that are defined over the total area of the line sensors. The actual series of distance-measuring zones are defined as shown in FIG. 5; however, three distance-measuring zones SZ1-SZ3 are defined in FIG. 4 for explanation purposes. Accordingly, a series of three fine photosensors M1-M3, M4-M6, and M7-M9, which monitors the line sensor's partial areas SZ1, SZ2, and SZ3, respectively, is defined. Each fine photosensor receives light that is substantially the same as the light incident on photodiodes in an opposite target area.

The AGC circuit 42_{HS} has three sections 42₃₁, 42₃₂, and 42₃₃, which corresponds to the zones 1 to 3, respectively. The sections 42₃₁, 42₃₂, and 42ⱼ₃ have AGC circuit elements AGC1-AGC3, AGC4-AGC6, and AGC7-AGC9, respectively, which are connected to the three fine photosensors M1-M3, M4-M6, and M7-M9, respectively. The threshold value for light incident on the three fine photosensors in one distance-measuring zone is set to the same value. Then, a different threshold value is set in each distance-measuring zone. For example, the same threshold value is set to the AGC circuit elements AGC1-AGC3. On the other hand, the threshold values for sections 42₃₁ and 42₃₂ are different from each other.

The timing of the completion of the accumulation of electric charges is determined in each distance-measuring zone. In the case of the distance-measuring zone 1, the accumulation of electric charges in the area SZ1 starts when a pair of object images is projected onto the focus detector's surface. Since the amount of light incident on each fine photosensor is different in accordance with the brightness distribution of an object, the output timing of the termination signal is different for each fine photosensor.

For example, when relatively strong light is incident on the fine photosensor M1 and relatively weak light is incident on the fine photosensors M2 and M3, the voltage level of the monitor signal input to the AGC1 reaches the threshold level earlier than the fine photosensors M2 and M3, and outputs a termination signal to the logic circuit 44 earlier. The logic circuit 44 terminates the accumulation of electric charges for the partial area SZ1 in response to the termination signal. Electric charges accumulated in the partial area SZ1 are temporarily stored in capacitors (herein, not shown). Similarly, when the AGC2 or AGC3 outputs the termination signal first, the accumulation of electric charges in the partial area SZ1 is terminated. Such an accumulation of electric charges is similarly carried out in the partial area SZ2 and SZ3. Such control of the accumulation of electric charges is carried out for each partial area on the line sensors LSA1-LSA9 and LSB1-LSB5 shown in FIG. 2.

In the accumulation of electric charges for all of the line sensors, a series of image-pixel signals is output from each line sensor. On the other hand, when the accumulation of electric charges in some partial areas is not finished within a predetermined amount of time from the point when the accumulation of electric charges commences, the accumulation in those areas is competed though an amount of light does not reaches the threshold level. Image-pixel signals generated in the line sensor groups EA1 and EA2, which are located in the upper and low areas (see FIG. 2), are transferred to the row-circuit 46, whereas image-pixel signals generated in the line sensor groups EB1 and EB2, which are located in the left and right areas, are transferred to the row-circuit 45.

FIG. 5 shows the actual defined distance-measuring zones that correspond to the arrangement of the line sensor groups shown in FIGS. 2 and 3. The scanning directions of the line-sensor group EA1 and the line-sensor group EB1 are also illustrated. The distance-measuring zones DA1, DA2, DA3, DA4, . . . , defined in the line sensor group EA1, are traverse to the line sensors LSA1-LSA9 extending across the left-right direction. On the other hand, the distance-measuring zones DB1, DB2, DB3, DB4, DB5, DB6, DB7, . . . , defined in the line sensor group EB1, are traverse to the line sensors LSB1-LSB5 along the upper-low direction.

In the line sensor group EA1, a main scanning direction is set to the arrangement direction of the line sensors LSA1-LSA9, i.e., in the left-right direction. As described above, each line sensor has a plurality of pairs of photodiodes arranged along the upper-low direction. Electric charges accumulated in the pairs of photodiodes are read across the line sensors LSA1-LSA9 in the main scanning direction, one line by one line. In the case of the line sensor group EB1, the main scanning direction is defined along the upper-low direction. Electric charges accumulated in a plurality of pairs of photodiodes are read across the line sensors LSB1-LSB5 in the main scanning direction, one line by one line. The line sensor groups EA2 and EB2 (not shown in FIG. 5) are also scanned similarly to the line sensor groups EA1 and EB1.

A series of image-pixel signals read by the above scanning method are amplified in the row circuits 45 and 46 shown in FIG. 3. As described above, the threshold value for the AGC circuit is different in each distance-measuring zone. Accordingly, when the gain process is carried out in the row circuits 45 and 46, the value of a gain applied to the image-pixel signals that are read from the line sensors is also different in each distance-measuring zone. Therefore, when a scanned line moves to a next distance-measuring zone, the value of the gain is changed. The amplified image-pixel signals are output to the system control circuit 30 via offset circuits 62 and 64, and switches 66 and 68, respectively. Those series of processes—the accumulation of electric charges and the reading of image-pixel signals—are repeatedly carried out during the AF process.

The system control circuit 30 selectively samples or detects monitor signals from certain AGC circuit elements. A monitor output selection circuit 56 outputs monitor signals designated by the system control circuit 30 to the system control circuit 30 via the switches 66 and 68, respectively. Also, OB monitor signals are output to the system control circuit 30 via a monitor signal selection circuit 52 and the switch 68. The standard voltage level of the monitor signal and the OB monitor signals are shifted or offset by level shift circuits 53 and 55, respectively.

Also, the system control circuit 30 detects the timing of the termination of the accumulation of electric charges. The logic circuit 44 outputs a signal that indicates the termination timing of the accumulation of electric charges for a given line sensor's partial area to the system control circuit 30 via a selection circuit 58. Furthermore, the logic circuit 44 outputs a signal that indicates the termination timing of the accumulation of electric charges for all of the line sensors to the system control circuit 30 via a selection circuit 60. The system control circuit 30 adjusts the period of accumulation of electric charges in each line sensor and a gain value of the AGC circuit on the basis of the above monitor signals and the termination timing signals.

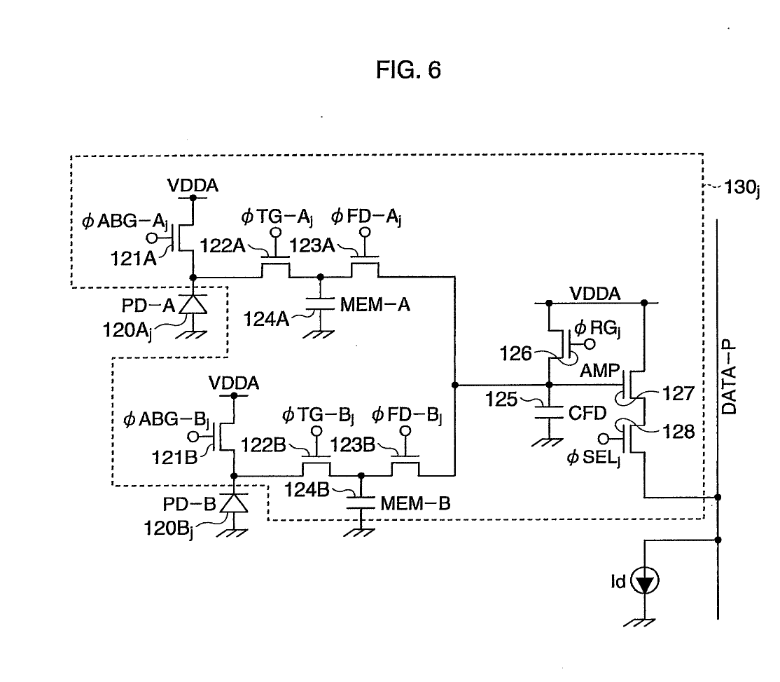

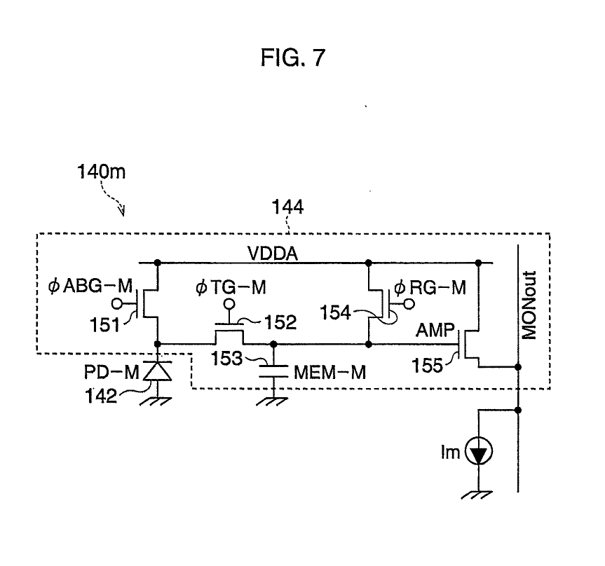

Hereinafter, an image-pixel signal-reading circuit for a line sensor and a monitor sensor is explained with reference to FIGS. 6 and 7.

FIG. 6 is a schematic diagram of one image-pixel signal-reading circuit for the line sensor (hereinafter, called an “LSR circuit”). FIG. 7 is a schematic diagram of one image-pixel signal-reading circuit for the monitor sensor (hereinafter, called an “MSR circuit”).

In FIG. 6, one pair of photodiodes 120Aⱼ and 120Bⱼ in the line sensor LSB3 are shown in relationship to the LSR circuit 130ⱼ. Both of the photodiodes 120Aⱼ and 120Bⱼ are connected to the LSR circuit 130ⱼ.

The LSR circuit 130ⱼ is equipped with anti-blooming gates (ABG) 121A and 121B such as a transistor, transfer gates (TG) 122A and 122B, and capacitors 124A and 124B for storing electric charges temporarily. The transfer gates 122A and 122B transfer electric charges accumulated in the photodiode pair 120Aⱼ and 120Bⱼ to the capacitors 124A and 124B. Furthermore, the LSR circuit 130ⱼ has an electric charge detection mechanism 133 based on FDA (Floating Diffusion Amplifier); namely, floating diffusion gates (FD) 123A and 123B, a floating diffusion capacitor (CFD) 125 for converting an electric charge to a voltage, a reset gate (RG) 126, a source-follower amplifier 127, and a selection gate 128.

On the other hand, In the fine photosensor 140ₘ shown in FIG. 7, the photoelectric converter 142 is connected to the MSR circuit (image-pixel signal output circuit for the monitor sensor) 144. The MSR circuit 144 is equipped with an anti-blooming gate (ABG) 151, a transfer gate (TG) 152, a reset gate (RG) 154, a capacitor (MEM) 153, and a source-follower amplifier 155.

In an AF process, electric charges are generated and accumulated in the series of photodiodes 120Aⱼ and 120Bⱼ of the line sensor LSB3. On the other hand, electric charges generated in the photoelectric converter 142 of the fine photosensor 140ₘ are successively converted to a voltage by the capacitor 153 and transmitted to the AGC circuit (see FIG. 2) via the source-follower amplifier 155.

Herein, the fine photosensor 140ₘ monitors eight pairs of photodiodes to check incident light; i.e., it compares the signal level of electric charges to the threshold value in order to prevent at least one of eight pairs of photodiodes from receiving incident light that exceeds a dynamic range, as described above. The accumulation of electric charges generated in each of the eight pairs of photodiodes continues until the signal level detected by the fine photosensor 140ₘ exceeds the threshold value.

When the signal level exceeds the threshold value, the accumulation of electric charges for all eight pairs of photodiodes is terminated. The accumulated electric charges in the pair of photodiodes 120Aⱼ and 120Bⱼ are transmitted to the capacitors 124A and 125B, respectively, via the transfer gates 122A and 122B. The transmitted electric charges are temporarily stored in the capacitors 125A and 125B until the accumulation of electric charges for all of the remaining pairs of photodiodes in the other line sensors is terminated. The transfer period of the electric charges is controlled by the logic circuit 44.

When the accumulation of electric charges for every pair of photodiodes is finished, the electric charges stored in the capacitors 124A and 124B are simultaneously transmitted to the floating diffusion capacitor 125 in the LSR circuit 130ⱼ. Consequently, electric charges generated in the photodiode 120Aⱼ and electric charges generated in the photodiode 120Bⱼ are mixed together and converted to voltage signals. The voltage signals are amplified by the source-follower amplifier 127 and output to the row circuit 45 or 46.

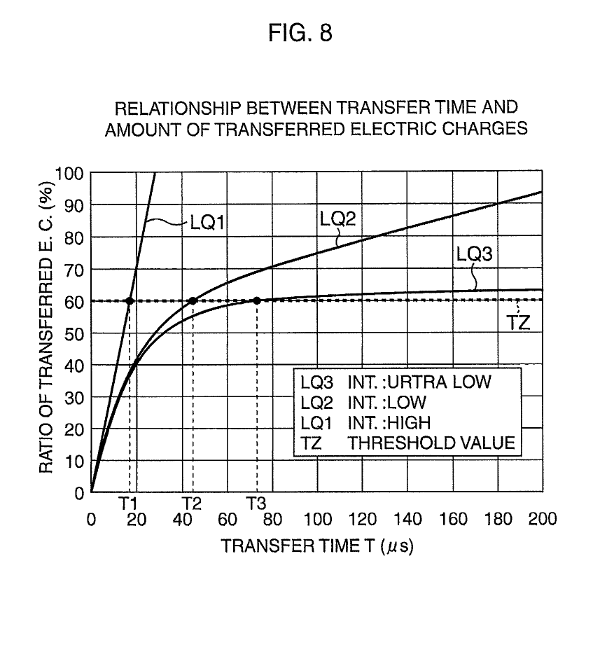

Next, a relationship between intensity of light incident on the line sensor and an amount of transferred electric charge is explained with reference to FIG. 8.

FIG. 8 is a graph representing a relationship between a time interval of an electric charge transfer and the quantity of electric charges to be transferred. The horizontal axis represents the time required to transfer accumulated electric charges from a photodiode to a capacitor. The vertical axis represents the ratio (%) of electric charges stored in the capacitor to the saturation quantity of electric charges.

Herein, functions LQ1, LQ2, and LQ3 based on three types of incident light having high intensity, low intensity, and ultra low intensity, respectively, are illustrated. In the case of the function LQ1 corresponding to high-intensity light, the amount of electric charges that can be transferred to the capacitor is proportional to the transfer time. On the other hand, in the case of the functions LQ2 and LQ3 corresponding to relatively low-intensity light, the amount of transferred electric charges increases but at a decreasing rate with respect to the transfer time as time increases. As can be seen from the graph shown in FIG. 8, the transfer speed of electric charges varies with respect to the intensity of incident light.

The threshold value in the AGC circuit corresponds to a line “TZ”. As described above, an accumulation of electric charges in a line sensor target area is terminated when the voltage level of a monitor signal reaches the threshold value. This value is decided such that an adequate quantity of electric charges is obtained to correctly detect the brightness level of an object image. Herein, approximately 60% of the saturation level of electric charges corresponds to an adequate amount of electric charges to be accumulated in the photodiode.

Therefore, electric charges accumulated in excess of the threshold value are surplus electric charges and are unnecessary for detecting an in-focus state. In the case of high-intensity light represented by the function LQ1, the accumulation of surplus electric charges starts immediately after transfer time T1. Then, a large quantity of surplus electric charges exceeding the line TZ are soon accumulated in a short period of time because the amount of electric charges transferred is proportional to the transfer time.

Consequently, while transferring accumulated electric charges from the photodiode to the capacitor after the monitor signal reaches the threshold level, surplus electric charges obtained after the exposure is terminated are transferred to the capacitor and mixed with the targeted accumulated electric charges. In the case of high-intensity light, a greater amount of surplus electric charges is accumulated as the transfer time increases.

On the other hand, in the case of low-intensity light represented by the function LQ2, surplus electric charges do not increase nearly as much after the transfer time passes time T2. Also, in the case of ultra-low intensity light represented by the function LQ3, surplus electric charges do not substantially occur after the transfer time passes time T3. Therefore, in the case of weak light, the transfer time should be set to a long interval in order to ensure that the all of the accumulated electric charges are transferred. The transfer time should be set as long as possible especially when the transfer time passes a tolerance period, i.e., reaches a tolerance time limit before the monitor signal reaches the threshold level.

In the present embodiment, an electric charge transfer time is determined in accordance to the intensity of incident light. Specifically, the higher the intensity of incident light, the shorter a transfer time becomes. Herein, intensity of light is regarded as a constant during an accumulation (integration) period, and the intensity of light is obtained from a detected integration period.

On the other hand, when an exposure period, i.e., an accumulation period, is forced to terminate in a state that the monitor signal does not reach the threshold level due to weak incident light, the electric charge transfer time is set in accordance to the amount of accumulated electric charges. Specifically, the lower the quantity of accumulated electric charges, the shorter the transfer time becomes. Note that surplus electric charges are not transferred to the capacitor when the intensity of light is extremely weak.

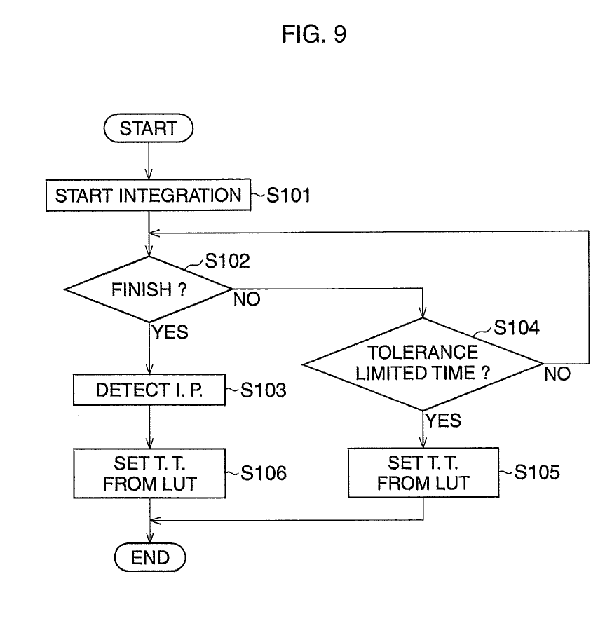

FIG. 9 shows a flowchart representing a control process for an electric charge transfer time, which is carried out by the logic circuit 44. An electric charge transfer time is set in each distance-measuring zone.

In Step S101, the accumulation of electric charges commences. Then, in Step S102, it is determined whether an accumulation of electric charges has been terminated. Concretely speaking, an accumulation of electric charges is started by opening and closing a reset gate for a monitor sensor (RG-M) and a reset gate for a line sensor (RG-L), and it is determined whether or not a monitor signal from an ACG circuit is a termination signal informing that the signal level has reached the threshold level.

When it is determined that the monitor signal is the termination signal, an integration or accumulation period from the start to the finish of an accumulation of electric charges is detected by using pulse counters provided in the logic circuit 44 (S103). Then, an electric charge transfer time corresponding to the detected integration period is selected from a LUT (Look-Up Table), which is prepared in advance (S106).

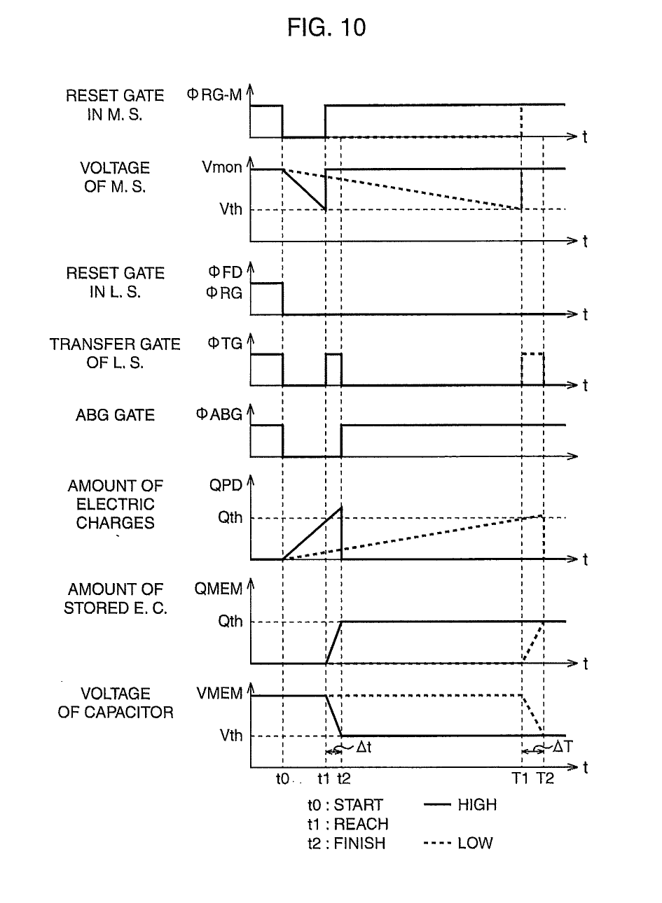

FIG. 10 is a timing chart for an electric charge transfer process. In FIG. 10 depicts an operation in a state in which high-intensity light is incident on a line sensor/monitor sensor and an operation in a state in which low-intensity light is incident on a line sensor/monitor sensor.

The accumulation of electric charges commences at time “t₀” by the opening and closing of the reset gates for the line sensor and monitor sensor. When the intensity of incident light is high, the amount of electric charges accumulating in the monitor sensor soon reaches the threshold level Qth, as shown by the solid line. A corresponding ACG circuit element outputs a termination signal to the logic circuit 44. The logic circuit 44 opens and closes the transfer gate (ΦTG) to transfer the accumulated electric charges to the capacitor (QMEM).

A transfer time or period Δt (=t₂−t₁) is determined at this time in accordance with the integration time (t₁−t₀). In the LUT, a relationship between the series of integration periods and the series of electric charge transfer times is represented. Each transfer time in the LUT is theoretically and experimentally predetermined in consideration of the transfer characteristics of the line sensor shown in FIG. 8 to avoid transferring surplus electric charges as much as possible.

In the case of relatively low-intensity incident light, the accumulation speed of electric charges is relatively slow. In FIG. 10, the amount of accumulated electric charges reaches the threshold level Qth at a time close to the tolerance-limited time T1. In this case, the transfer time ΔT (=T₂−T₁) is determined in accordance to the integration time (T₁−t₀). The time interval or period “Δt” is shorter than “ΔT”.

On the other hand, when it is determined at Step S102 that an accumulation of electric charges has not finished, whether the integration period has reached the tolerance-limited time T1 is then determined (S104). When the accumulation time does not reach the tolerance-limited time T1 due to weak light, the accumulation of electric charges terminates and a transfer time is determined in accordance to the amount of electric charges accumulated at that time (S105).

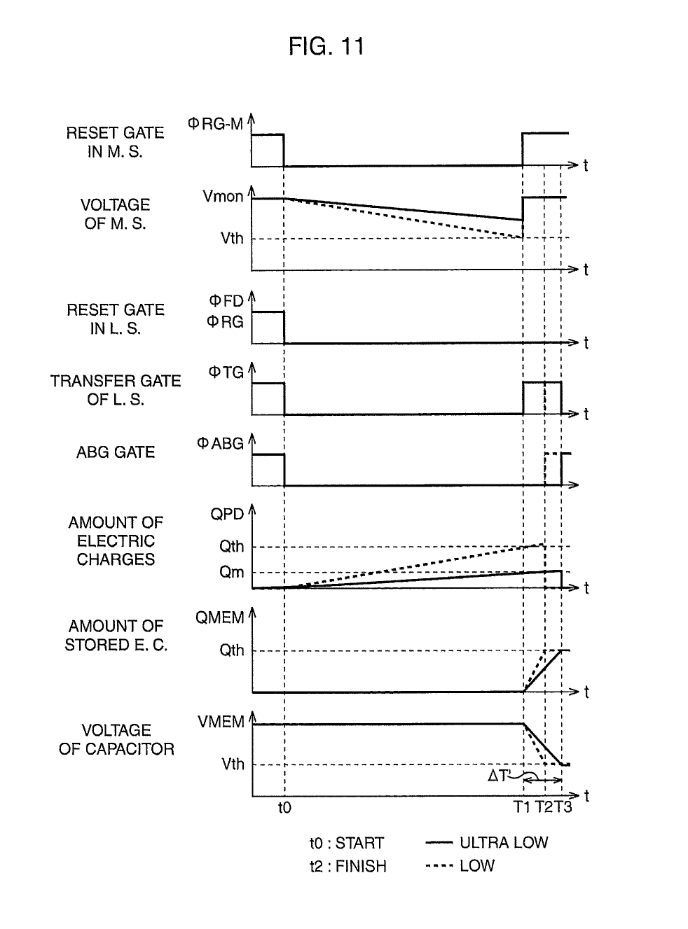

FIG. 11 is a timing chart in a case characterized by extremely weak incident light. When the accumulation time reaches the tolerance-limited time T1 before the amount of electric charges reaches the threshold level “Qth”, a transfer time interval or period ΔT′ is determined in accordance to the amount of accumulated electric charges “Qm”. Herein, a transfer time is set such that the lower the amount of accumulated electric charges “Qm” is, the longer the transfer time ΔT′ is. Concretely, the transfer time ΔT′ is determined by using the LUT that represents the relationship between a series of transfer times and a series of accumulated electric charge quantities. The transfer time ΔT′ is at minimum longer than the transfer time for an accumulation of electric charges that finishes at substantially the tolerance-limited time T1. Note that, the logic circuit utilizes an amount of accumulated electric charges that are detected during a gain process. The transfer time ΔT′ increases as the value of the gain increases. Concretely, the level of monitor signal at the tolerance-limited time T is compared with one half, quarter, eights, sixteenths, of the threshold value. Accordingly, the value of gain is set to ½, ¼, ⅛, or ⅙. The transfer time ΔT′ is decided in accordance to the value of gain.

In this way, in the present embodiment, an amount of electric charges accumulated in the line sensor is compared with the threshold level on the basis of the monitor signal from the AGC circuit. When the amount of electric charge reaches the threshold level, the transfer gate opens so that the accumulated electric charges are stored in the capacitor. At this time, a transfer time is decided in accordance to an accumulation or integration time until the attaining to the threshold level.

When an integration time is short, a relatively short transfer time is set. The shorter the integration time is, the shorter the transfer time is. Thus, surplus electric charges are not transferred to the capacitor so that the AF process can be carried out on the basis of the correct brightness level of an object. On the other hand, when an integration time passed the tolerance-limited time, a relative long transfer time is set. The larger the amount of accumulated electric charges, the longer the transfer time is. Thus, the all of accumulated electric charges are transferred to the capacitor, so that the adequate AF process can be carried out even though the brightness of an object is not sufficient.

The quantity of electric charges accumulated in a line sensor, i.e., an amount of light that a line sensor receives may be detected without a monitor sensor. For example, a logic circuit or a CPU directly detects an amount of light. As for the focus-measurement method, either multiple focal point measurement or center focal point measurement may be applied. The number of line sensors and monitor sensors, or the number of line-sensor groups may be optionally set in accordance with the size and outline of the projection area. The AF module may be installed in another device with a photographing function, such as a cellular phone.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2009-265419 (filed on Nov. 20, 2009), which is expressly incorporated herein by reference, in its entirety.

1. An apparatus for detecting an in-focus state, comprising:
a plurality of line sensors arranged on a projection area of an optical image-forming system, each line sensor comprising photoelectric converters and storage;
a plurality of monitor sensors arranged on the projection area, each monitor sensor being adjacent to a corresponding line sensor and monitoring a quantity of light incident on a corresponding line sensor;
an accumulation termination detector that detects when an accumulation of electric charges in said plurality of line sensors is terminated on the basis of monitor signals output from said plurality of monitor sensors;
an electric charge transfer processor that transfers electric charges accumulated in said photoelectric converters to said storage;
a signal output processor that reads electric charges temporarily stored in said storage to output image signals corresponding to an object image; and
an electric charge transfer controller that adjusts an electric charge transfer time interval of a target line sensor in response to the intensity of light incident on a corresponding monitor sensor.

2. The apparatus of claim 1, wherein said electric charge transfer controller makes an time interval for an electric charge transfer of relatively weak light compared with an electric charge transfer time interval for relatively strong light.

3. The apparatus of claim 1, wherein said electric charge transfer controller decreases the time interval for an electric charge transfer as the intensity of incident light increases.

4. The apparatus of claim 1, wherein said electric charge transfer time controller adjusts an electric charge transfer time when an amount of accumulated electric charges does not reach a threshold level during a tolerance period, said electric charge transfer controller making an electric charge transfer time interval long compared with an electric charge transfer time corresponding to a tolerance time limit.

5. The apparatus of claim 1, wherein said electric charge transfer time controller adjusts an electric charge transfer time interval when a quantity of accumulated electric charges does not reach a threshold level during a tolerance period, said electric charge transfer controller increasing an electric charge transfer time interval as the quantity of electric charges decreases.

6. The apparatus of claim 1, wherein said accumulation termination detector compares a monitor signal output from each monitor sensor with a threshold level, said electric charge transfer controller adjusting an electric charge transfer time in response to a period until the monitor signal reaches the threshold level.

7. The apparatus of claim 1, wherein a series of distance-measuring zones is defined on said plurality of line sensors, said electric charge transfer controller setting a common electric charge transfer time for line sensors arranged in the same distance-measuring zone.

8. The apparatus of claim 1, wherein each line sensor comprises a transfer gate that transmits the accumulated electric charges to said storage, said electric charge transfer controller controlling an opening and closing of said transfer gate.

9. A camera comprising:
a photographing optical system that forms an object image on an image sensor:
an apparatus for detecting an in-focus state that is recited in claim 1, said apparatus outputting image signals on the basis of light passing through said photographing optical system; and
an AF adjuster that brings an object image into focus by driving a focusing lens in said photographing optical system on the basis of the output image signals.

10. An apparatus for detecting an in-focus state, comprising:
a plurality of line sensors arranged on a projection area of an optical image-forming system, each line sensor comprising photoelectric converters and storage;
an electric charge transfer processor that transfers electric charges accumulated in said photoelectric converters to said storage;
a signal output processor that converts electric charges temporarily stored in said storage to output image signals corresponding to an object image; and
an electric charge transfer controller that adjusts an electric charge transfer time interval of a target line sensor in response to the intensity of incident light.
